(19) United States
(12) Patent Application Publication
(10) Pub. No.: US 2007/0096629 A1
(43) Pub. Date: May 3, 2007

(54) Electron emission display

(75) Inventors: Kyu-Won Jung, Yongin-si (KR); Il-Hwan Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/589,039

(22) Filed: Oct. 30, 2006

(30) Foreign Application Priority Data
Oct. 31, 2005 (KR) 10-2005-0103350

(51) Int. Cl. H01J 63/04; H01J 1/62

(52) U.S. Cl. 313/496

(57) ABSTRACT

An electron emission display includes first and second substrates facing each other, electron emission regions to emit electrons and formed on the first substrate, and driving electrodes formed on the first substrate to use in the control of the emission of electrons from the electron emission regions. Phosphor layers are formed on a surface of the second substrate. An anode electrode is placed on a surface of the phosphor layers. Spacers are mounted between the first and the second substrates. Antistatic electrodes are placed over the first substrate such that the antistatic electrodes are insulated from the driving electrodes, and electrically connected to the spacers.

### CROSS-REFERENCE TO RELATED APPLICATION

This application claims the benefit of Korean Application No. 2005-103350, filed on Oct. 31, 2005 in the Korean Intellectual Property Office, the disclosure of which is incorporated herein by reference.

### BACKGROUND OF THE INVENTION

1. Field of the Invention

Aspects of the present invention relate to an electron emission display. In particular, aspects of the present invention relate to an electron emission display which has spacers mounted within a vacuum vessel to withstand the pressure applied thereto.

2. Description of the Related Art

Generally, electron emission elements are classified into different types depending upon the types of electron sources. These include a first type using a hot cathode and a second type using a cold cathode. The second type electron emission elements using a cold cathode include a field emitter array (FEA) type, a surface conduction emission (SCE) type, a metal-insulator-metal (MIM) type, and a metal-insulator-semiconductor (MIS) type. To construct an electron emission display, arrays of electron emission elements are arranged on a first substrate, which together form an electron emission device. The electron emission device is assembled with a second substrate having a light emission unit with phosphor layers and an anode electrode. Accordingly, an electron emission display is constructed.

An electron emission device commonly includes electron emission regions, and a plurality of electrodes for functioning as scanning and driving electrodes. The electron emission regions and the scanning and driving electrodes are used in controlling the emission of electrons from pixels formed by intersecting scanning and driving electrodes and the amount of electrons emitted from the electron emission regions. In the electron emission display, the electrons emitted from the electron emission regions excite phosphor layers formed in the second substrate causing emission of light and display of desired images.

To form the electron emission display, the first substrate with the electron emission regions and the scanning and driving electrodes and the second substrate with the light emission unit are sealed to each other at their peripheries using a sealing member. Once sealed, the internal space thereof is evacuated to about 10⁻⁶ torr. Accordingly, a vacuum vessel is constructed together with the sealing member. The vacuum vessel is subjected to high pressure due to the pressure difference between the interior and exterior of the vacuum vessel. The pressure applied to the vacuum vessel is increased in proportion to the screen size of the vacuum vessel.

A plurality of spacers is mounted between the first and the second substrates to withstand the pressure applied to the vacuum vessel, and maintain the distance between the two substrates. The spacers are formed with a material having excellent strength but no conductivity, such as glass or ceramic. The spacers are located at an area of the second substrate formed by a black layer so as to not intrude upon other areas of the phosphor layers.

However, during operation of the electron emission display, it is difficult to completely emit the electron beams in a straight manner. That is, while most of the electrons emitted from the electron emission regions of the first substrate are diffused or attracted toward the phosphor layers of the second substrate, some of the electrons are diffused or scattered by a predetermined diffusion angle. The diffused electrons collide against the surface of the spacers due to the diffusion of some of the electrons of the electron beams. Accordingly, the spacers become surface-charged with a positive or negative potential depending upon the material characteristics thereof, such as a dielectric constant and a secondary electron emission coefficient.

The surface-charged spacers vary the electric fields around the spacers. Accordingly, the trajectories of the electron beams are distorted. For instance, the spacers charged to be in a positive potential attract the electron beams, and the spacers charged to be in a negative potential repel the electron beams. The distortion in the trajectories of the electron beams hinders the correct expression of color in areas of the phosphor layers around the spacers. Accordingly, in the areas of a screen around the spacers, the display quality deteriorates.

### SUMMARY OF THE INVENTION

Aspects of the present invention provide an electron emission display which draws out charges on a surface of spacers to prevent or reduce the distortion in electron beams and the deterioration in the display quality due to charging of the spacers.

According to an aspect of the present invention, an electron emission display includes first and second substrates facing each other, electron emission regions to emit electrons and formed on the first substrate, and driving electrodes formed on the first substrate to use in the control of the emission of electrons from the electron emission regions. Phosphor layers are formed on a surface of the second substrate. An anode electrode is placed on a surface of the phosphor layers. Spacers are arranged between the first and the second substrates. Antistatic electrodes are placed over the first substrate such that the antistatic electrodes are insulated from the driving electrodes, and electrically connected to the spacers.

The antistatic electrode may be placed over the topmost portion of the first substrate.

A focusing electrode may be placed over the driving electrodes such that the focusing electrode is insulated from the driving electrodes. In this case, the antistatic electrode may be placed on the same plane as the focusing electrode such that the antistatic electrode is spaced apart from the focusing electrode by a distance. The antistatic electrode may have a width smaller than that of the spacer.

The spacer may be attached to the antistatic electrode via a low resistance adhesive layer. The spacer may be formed with a spacer body based on at least one of glass and ceramic, and a high resistance coating film placed on the lateral side of the spacer body.

According to another aspect of the present invention, a spacer of an electron emission display that supports a space between two substrates of the electron emission display includes: a body; and an electrode connected to one end of the body, wherein a width of the electrode is equal to or narrower than a width of the body to enhance voltage resistance of the electrode.

According to another aspect of the present invention, an electron emission display includes: a first substrate; at least one electron emitter to emit electrons formed on the first substrate; a second substrate; at least one spacer formed between the first and second substrates to support the first and second substrates; and at least one electrode formed between the first substrate and the at least one spacer, wherein an electric field from the at least one electrode hinders the electrons from colliding with the at least one spacer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a partial exploded perspective view of an electron emission display according to an aspect of the present invention;

FIG. 2 is a partial sectional view of an electron emission display shown in FIG. 1; and

FIG. 3 is a partial plan view of an electron emission shown in FIG. 1.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

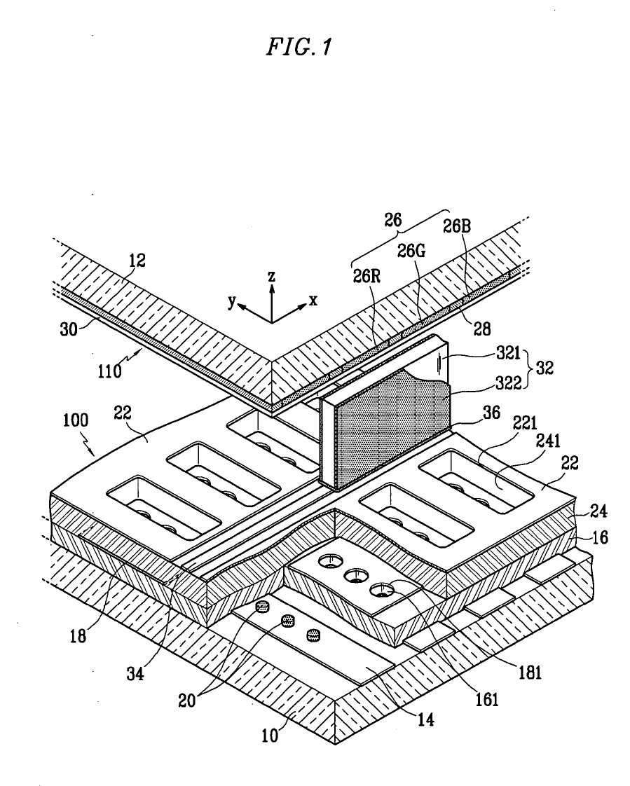

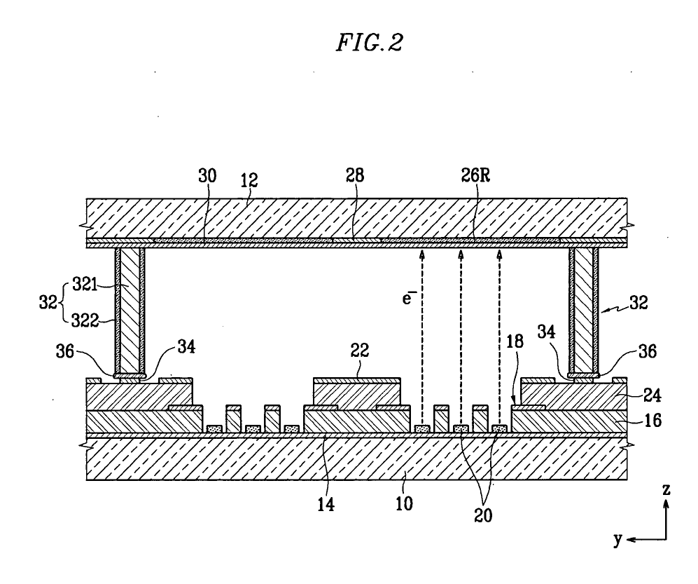

FIGS. 1 and 2 are a partial exploded perspective view and a partial sectional view of electron emission display according to an aspect of the present invention, respectively. Although not required in all aspects, an FEA type electron emission display is shown in FIGS. 1 and 2.

As shown in FIGS. 1 and 2, the electron emission display 1 includes parallel first and second substrates 10 and 12 facing each other by a predetermined distance. A sealing member (not shown) is provided at the peripheries of the first and the second substrates 10 and 12 to seal them to one another. Once sealed, the inner space thereof is evacuated to about 10⁻⁶ torr. Accordingly, a vacuum vessel is constructed from the first and the second substrates 10 and 12 and the sealing member.

To form an electron emission device 100 on the first substrate 10, arrays of electron emission elements are arranged on a surface of the first substrate 10 facing the second substrate 12. The electron emission device 100 is combined with the second substrate 12 having a light emission unit 110. Accordingly, an electron emission display device 1 is constructed.

In the electron emission device 100 are cathode electrodes (or electrode) 14 (the first electrodes) formed on the first substrate 10 in a first direction of the first substrate 10. The cathode electrodes 14 are stripe-patterned or band shaped. Also a first insulating layer 16 is formed on the entire surface of the first substrate 10 to cover the cathode electrodes 14. Gate electrodes (or electrode) 18 (the second electrodes) are formed on the first insulating layer 16 in a second direction perpendicular to the cathode electrodes 14. The gate electrodes 18 are stripe-patterned or band shaped.

In this aspect, when the crossed (or intersected) regions (or a region) of the cathode and the gate electrodes 14 and 18 are defined as pixels (or a pixel), electron emission regions 20 are formed on the cathode electrodes 14 of the respective pixels. Opening portions (or openings) 161 and 181 are respectively formed in the first insulating layer 16 and the gate electrodes 18, and at positions corresponding to the electron emission regions 20 to expose the electron emission regions 20 formed on the first substrate 10.

The electron emission regions 20 are formed with a material that emits electrons when an electric field is applied thereto under a vacuum atmosphere. Examples of such materials include a carbonaceous material and a nanometer-sized material. For instance, the electron emission regions 20 may be formed with carbon nanotube (CNT), graphite, graphite nanofiber, diamond, diamond-like carbon (DLC), fullerene (C₆₀), silicon nanowire, or a combination thereof. Alternatively, the electron emission regions 20 may be formed with a sharp-pointed tip structure based mainly on molybdenum Mo, silicon Si, or a combination thereof. Such a sharp-pointed tip structure is referred to as a spindt-type structure.

In the aspect shown in FIGS. 1 and 2, the electron emission regions 20 are circular-shaped and are linearly arranged in the longitudinal direction of the cathode electrodes 14. However, it is understood that the shape, number per pixel, and arrangement of the electron emission regions 20 are not limited to those illustrated, but may be altered in various manners. In various aspects, the shapes of the electron emission regions 20 may be oval, rectangular, or the like. The number per pixel may be three, more than three, or less than three. Also, the arrangement may be a pairing, a clustering, or the like.

Furthermore, although the gate electrodes 18 are shown as being placed over the cathode electrodes 14 to interpose a first insulating layer 16 in between them, the gate electrodes 18 may also be placed under the cathode electrodes 14 and have the first insulating layer 16 interposed between them, in other aspects. In the latter case, the electron emission regions 20 may be formed at the lateral sides of the cathode electrodes 14 formed on the first insulating layer 16.

A focusing electrode (or electrodes) 22 (third electrode) is formed on the gate electrodes 18 and the first insulating layer 16. A second insulating layer 24 is placed under the focusing electrode 22 to insulate the gate electrodes 18 from the focusing electrode 22. Opening portions (or openings) 221 and 241 are formed in the focusing electrode 22 and the second insulating layer 24 to pass the electron beams. The opening portions 221 and 241 are formed on the respective pixels one over the other such that the focusing electrode 22 collectively focuses the electrons emitted from each pixel.

In the other substrate 12, phosphor layers 26, including red, green and blue phosphor layers 26R, 26G, and 26B, are formed on a surface of the second substrate 12 that faces the first substrate 10. The first and second substrates 10 and 12 are spaced apart from each other by a distance. A black layer 28 is formed in the phosphor layer 26 between the respective red, green, and blue phosphor layers 26R, 26G, and 26B to enhance a screen contrast. The phosphor layers 26R, 26G, and 26B are located at the pixels defined on the first substrate 10 such that each of the colored phosphor layers 26R, 26G, and 26B corresponds to each pixel.

An anode electrode 30 is formed on the phosphor layers 26 and the black layer 28. The anode electrode 30 is formed of a metallic material, such as aluminum Al. The anode electrode 30 receives a high voltage required to accelerate the electron beams from the electron emission regions 20, and makes the phosphor layers 26 be in a high potential state. The anode electrode 30 reflects visible rays that radiate from the phosphor layers 26 in the direction of the first substrate 10 toward the second substrate 12 resulting in increased screen luminance.

Alternatively, the anode electrode 30 may be formed with a transparent conductive material, such as indium tin oxide (ITO). The anode electrode 30 of ITO may be placed under the surface of the phosphor layers 26 and the black layer 28 so that the anode electrode 30 is positioned between the phosphor layers 26 and the black layer 28 on the second substrate 12. Also, in other aspects, the transparent conductive layer or material and the metallic layer or material may be used simultaneously as layers or materials for the anode electrode 30.

In the electron emission display 1 according to an aspect of the present invention, spacers 32 are arranged between the first and the second substrates 10 and 12 to withstand the pressure applied to a vacuum vessel (the electron emission display) and maintain the distance between the two substrates 10 and 12. The spacers 32 are placed within an area of the second substrate 12 having the black layer 28 so as to not intrude upon the area of the phosphor layers 26 having the color phosphor layers 26R, 26G, and 26B. In the aspect shown, wall type spacers are illustrated. However, it is understood that other types of spacers are usable. These include column shaped, truss shaped, lattice shaped, or the like.

The spacer 32 may be formed with a spacer body 321 based on glass or ceramic, and a coating film 322 covering the lateral side of the spacer body 321. In various aspects, the coating film 322 may be a film having high resistance. Also, in this aspect, the spacer 32 is electrically connected to a separate antistatic electrode (or electrodes) 34 to minimize surface-charging of the spacer 32.

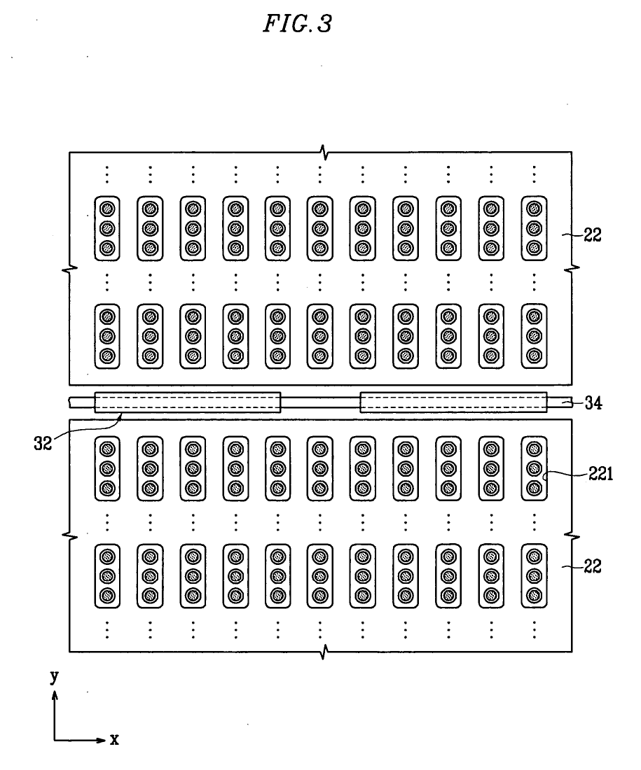

For this purpose, as shown in FIGS. 2 and 3, a portion of the focusing electrode 22 contacting the spacer 32 is removed (or is absent) to expose the surface of the underlying second insulating layer 24. The antistatic electrode 34 is formed on the exposed surface portion of the second insulating layer 24 and is spaced apart from the focusing electrode 22. In other words, the antistatic electrode 34 and the focusing electrodes are separated and not in direct contact.

The focusing electrode 22 and the antistatic electrode 34 may be formed with the same conductive material. For example, a conductive film may be coated on the entire surface of the second insulating layer 24 as a precursor to the focusing and antistatic electrodes 22 and 34. Subsequently, a boundary portion between the focusing electrode 22 and the antistatic electrode 34 may be etched to insulate (e.g., electrically disconnect or isolate) the two electrodes 22 and 34 from each other. The antistatic electrode 34 may be formed with a width smaller than the spacer 32 to enhance the voltage resistance characteristic of the antistatic electrode 34 with respect to the focusing electrode 22. In other aspects, the width of the antistatic electrode 34 may be formed wider than the spacer 32 to increase stability.

The spacer 32 is attached to the antistatic electrode 34 via a low resistance adhesive layer 36 which enables an electrical connection. The antistatic electrode 34 receives a separate or an independent voltage from that of the other electrodes, for example, the focusing electrode 22, to prevent or reduce the spacer 32 from being surface-charged. For instance, the antistatic electrode 34 receives a negative direct current (DC) voltage higher than that of the focusing electrode 22.

The antistatic electrodes 34 receive the negative direct current voltage higher than the focusing electrode 22 to repel the electrons that diffuse from the electron emission regions 20 toward the spacers 32. Accordingly, the negative direct current voltage prevents or reduces the electrons from colliding against the surface of the spacers 32. For instance, when a voltage of −20V is applied to the focusing electrode 22, a voltage of −30V is applied to the antistatic electrodes 34 to vary the distribution of electric fields at the boundary area between the focusing electrode 22 and the antistatic electrodes 34. In various aspects, the antistatic electrodes 34 receive a variable voltage varied depending upon the driving time of the electron emission display. Also, in other aspects, the antistatic electrodes 34 receive a fixed voltage.

Consequently, the electron collisions against the surface of the spacers 32 are minimized to prevent or reduce the surface charging of the spacer 32. The electrons that still collide against the surface of the spacers 32 are drawn out through the high resistance coating film 322, the low resistance adhesive layer 36 and the antistatic electrode 34. Accordingly, the spacers 32 are prevented or reduced from being surface-charged.

In other aspects, spacers 32 may be formed with various shapes such as a cylindrical or cross shape, in addition to the illustrated wall shape. Additionally, the spacers 32 may be a column shape, truss shape, lattice shape, or the like. The material for the coating film 322 provided on the lateral side of the spacer body 321 may be also altered in various manners. In various aspects, the antistatic electrode 34 may be formed of material different from the focusing electrode 22. Also, the antistatic electrode 34 need not be a strip but other shape, such as connected crosses. Using different shapes, the electric field of the antistatic electrode 34 may be varied as desired.

The above-structured electron emission display 1 is driven by supplying predetermined voltages to the cathode electrodes 14, the gate electrodes 18, the focusing electrode 22, the anode electrode 30, and the antistatic electrode 34.

For instance, any one of the electrodes of the cathode and the gate electrodes 14 and 18 may receive scanning driving voltages to function as scanning electrodes, and the other of the cathode and the gate electrodes 14 and 18 may receive data driving voltages to function as data electrodes. The focusing electrode 22 and the antistatic electrodes 34 may receive a voltage required to focus the electron beams, for example, 0V or a negative direct current voltage of several to several tens of volts (e.g., of the same polarity). The anode electrode 30 receives a voltage to accelerate the electron beams. For example, such a voltage may be a positive direct current voltage of several hundreds to several thousands of volts.

During operation of the electron emission display 1, electric fields are formed around the electron emission regions 20 at the pixels where the voltage difference between the cathode and the gate electrodes 14 and 18 exceeds a threshold value, and electrons are emitted from those electron emission regions 20. The emitted electrons then pass through the opening portions 221 of the focusing electrode 22, and are focused at or near the center of the bundles (or stream) of electron beams. The focused electrons are then attracted by the high voltage applied to the anode electrode 30, and collide against the respective phosphor layers 26R, 26G, and 26B.

During operation of the electron emission display 1, the antistatic electrodes 34 repel the electrons that are diffused toward the spacers 32. Accordingly, the amount of electrons colliding against the surface of the spacers 32 is minimized. Furthermore, the electrons that collide against the surface of the spacers 32 are drawn out through the high resistance coating film 322 and the antistatic electrodes 34 so that the spacers 32 are not surface-charged, and the beams of electrons passing around the spacers 32 are not distorted.

The above explanation is made with respect to an FEA type electron emission display. However, various aspects of the of the invention are not limited to the FEA typed, but may be applied to other types of electron emission displays, which include as an SCE type, an MIM type, and an MIS type, or the like.

As described above, in an electron emission display according to aspects of the present invention, antistatic electrodes are separately provided such that the antistatic electrodes are electrically connected to the spacers. Accordingly, even when the electrons emitted from the electron emission regions collide against the surface of the spacers, the spacers are not surface-charged and the electric fields formed around the spacers are not varied. Consequently, correct color expression is made around the spacers, and the spacers do not affect an image on a screen. Also, the spacers are not perceived on the screen. Accordingly, the display quality is enhanced.

Although a few aspects of the present invention have been shown and described, it would be appreciated by those skilled in the art that changes may be made in the aspects without departing from the principles and sprit of the invention, the scope of which is defined in the claims and their equivalents.

What is claimed is:

1. An electron emission display, comprising:
first and second substrates facing each other;
electron emission regions to emit electrons and formed on the first substrate;
driving electrodes formed on the first substrate to use in the control of the emission of electrons from the electron emission regions;
phosphor layers formed on a surface of the second substrate;
an anode electrode placed on a surface of the phosphor layers;
spacers mounted between the first and the second substrates; and
antistatic electrodes placed over the first substrate such that the antistatic electrodes are insulated from the driving electrodes, and electrically connected to the spacers.

2. The electron emission display of claim 1, wherein the antistatic electrode is placed over the topmost portion of the first substrate.

3. The electron emission display of claim 2, further comprising a focusing electrode placed over the driving electrodes such that the focusing electrode is insulated from the driving electrodes, wherein the antistatic electrode is placed on the same plane as the focusing electrode such that the antistatic electrode is spaced apart from the focusing electrode by a distance.

4. The electron emission display of claim 3, wherein the antistatic electrode has a width smaller than that of the spacer.

5. The electron emission display of claim 1, wherein the spacer is attached to the antistatic electrode via a low resistance adhesive layer.

6. The electron emission display of claim 1, wherein the spacer comprises a spacer body based on at least one of glass and ceramic, and a high resistance coating film placed on the lateral side of the spacer body.

7. The electron emission display of claim 1, wherein the antistatic electrode receives a variable voltage varied depending upon the driving time of the display device.

8. The electron emission display of claim 1, wherein the antistatic electrode receives a fixed voltage.

9. The electron emission display of claim 1, wherein the electron emission regions comprise at least one of carbon nanotube, graphite, graphite nanofiber, diamond, diamond-like carbon, fullerene (C₆₀), and silicon nanowire.

10. The electron emission display of claim 1, wherein the electrons from the electron emission regions are drawn out of the spacers through the antistatic electrodes.

11. The electron emission display of claim 1, wherein the electron emission regions are field emitter array (FEA) emitters.

12. An electron emission display, comprising:
a first substrate;
at least one electron emitter to emit electrons formed on the first substrate;
a second substrate;
at least one spacer formed between the first and second substrates to support the first and second substrates; and
at least one electrode formed between the first substrate and the at least one spacer, wherein an electric field from the at least one electrode hinders the electrons from colliding with the at least one spacer.

13. The electron emission display of claim 12, wherein a width of the at least one electrode is equal to or narrower than a width of the at least one spacer to enhance voltage resistance of the at least one electrode.

14. The electron emission display of claim 12, wherein the electrons emitted from the at least one electron emitter are drawn out of the at least one spacer through the at least one electrode.

15. The electron emission display of claim 12, wherein the at least one electrode is an antistatic electrode.
